(19) United States
(12) Patent Application Publication
(10) Pub. No.: US 2014/0372118 A1
(43) Pub. Date: Dec. 18, 2014

(54) METHOD AND APPARATUS FOR EXEMPLARY CHIP ARCHITECTURE

(71) Applicant: Speech Morphing Systems, Inc., Campbell, CA (US)

(72) Inventors: Fathy Yassa, Soquel, CA (US); Ben Reaves, Sunnyvale, CA (US)

(73) Assignee: Speech Morphing Systems, Inc., Campbell, CA (US)

(21) Appl. No.: 14/307,469

(22) Filed: Jun. 17, 2014

Related U.S. Application Data
(60) Provisional application No. 61/835,640, filed on Jun. 17, 2013.

(51) Int. Cl. G10L 15/26; G10L 15/18

(52) U.S. Cl. CPC G10L 15/26; G10L 15/18
USPC 704/235

(57) ABSTRACT

A dynamically configurable automatic speech recognizer where either or both of the acoustic model file and the language model file are changeable to improve the accuracy of human speech recognition.

### CROSS-REFERENCE TO RELATED APPLICATION

This patent application claims priority from U.S. Provisional Patent Application No. 61/835,640 filed on Jun. 17, 2013, in the U.S. Patent and Trademark Office, the disclosure of which is incorporated herein by reference in its entirety.

### Background

1. Field

Exemplary embodiments herein relate to a method and apparatus for performing speech recognition.

2. Description of Related Art

Typically speech recognition is accomplished through the use of an Automatic Speech Recognition (ASR) engine. An ASR works by obtaining audio of a phrase of one or more spoken words, converting the phrase into several potential textual representations, and assigning a confidence score each textual representation.

An ASR can be thought of as an engine and a model. For purposes of this disclosure, a speech engine takes a spoken utterance, compares the utterance to a vocabulary, and matches the utterance to words or phrases in the vocabulary. Speech recognition engines generally require two library files to recognize speech. The first library file is an acoustic model, which is created by taking audio recordings of speech and their associated transcriptions (taken from a speech corpus), and ‘compiling’ the transcriptions into a statistical representations of the sounds that make up each word (through a process called ‘training’). The second set of information is a language model, sometimes referred to a grammar file. A language model may be in the form of a file containing the probabilities of sequences of words. A grammar file is a much smaller type of language model file containing sets of predefined combinations of words. Language models are typically used for dictation applications, whereas a grammar files are generally used in desktop command and control or telephony interactive voice response (IVR) type applications.

Traditionally, both the acoustic model and the language model are static, i.e. they are hard wired as part of the ASR.

### SUMMARY

Exemplary embodiments of the present application relate to speech recognition using an ASR having a dynamically programmable language model, a dynamically programmable acoustic model, or both the dynamically programmable language model and the dynamically programmable acoustic model.

### DESCRIPTION OF THE DRAWINGS

FIG. 1 illustrates a system level diagram of a computer system, according to an exemplary embodiment.

FIG. 2 illustrates a schematic diagram one of the several embodiments.

FIG. 3 illustrates a schematic diagram one of the several embodiments.

FIG. 4 illustrates a schematic diagram one of the several embodiments.

FIG. 5 illustrates a flow diagram one of the several embodiments.

### DETAILED DESCRIPTION OF THE EXEMPLARY EMBODIMENTS

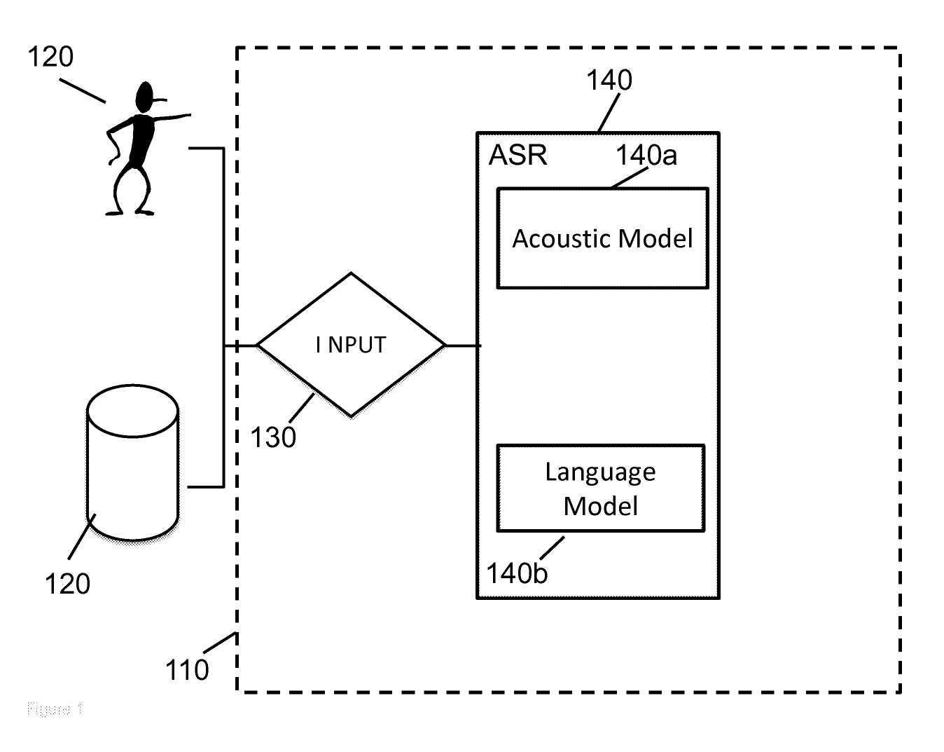

FIG. 1 illustrates a block diagram of a system for enhancing the accuracy of speech recognition according to an exemplary embodiment.

The speech recognition system in FIG. 1 may be implemented as a computer system 110; a computer comprising several modules, i.e. computer components embodied as either software modules, hardware modules, or a combination of software and hardware modules, whether separate or integrated, working together to form an exemplary computer system. The computer components may be implemented as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

Exemplary embodiments described herein may increase the accuracy and speed of an automatic speech recognizer (“ASR”) by dynamically updating its language model and the acoustic model.

Speech recognition (by a machine) is a very complex problem. Vocalizations vary in terms of accent, pronunciation, articulation, roughness, nasality, pitch, volume, and speed. Speech is distorted by background noise, echoes, and electrical characteristics. Accuracy of speech recognition may vary according to: vocabulary size and confusability; speaker dependence vs. independence; isolated, discontinuous, or continuous speech; task and language constraints; read vs. spontaneous speech; and adverse conditions.

Source 120 provides the source of a human speech to the system 110. Source 120 may be a live speaker, the public Internet, a data file, etc. Input 130 is a module configured to receive the human speech and digitize said speech into a machine readable form if the human speech has not already been digitized. ASR 140 is a module configured as an automatic speech recognizer to receive the speech in machine readable form and convert the speech into text. The ASR 140 includes acoustic model 140a and language model 140b.

Acoustic model 140a is a module configured to receive audio recordings of speech, and their text transcriptions, and create statistical representations of the sounds that make up each word. The acoustic model 140a is used by a speech recognition engine to recognize speech. ASR 140 compares the input human speech to the statistical representations of speech contained in the acoustic model 140a to determine the mostly likely textual translation for said speech. Textual translations of speech by the acoustic model 14a are generally in the form of diphones.

Language model 140b is a module configured to assign a probability to a sequence of “m” words by means of a probability distribution, i.e. a language model tries to capture the properties of a language, and to predict the next word in a speech sequence. One the acoustic model 140a has created a sequence of phonemes, ASR 140 uses the language model 140b determines the corresponding words and phrases through various probabilistic models.

As noted above, the ASR 140, acoustic model 140a and the language model 140b may be software modules, hardware modules, or a combination of software and hardware modules, whether separate or integrated, working together to perform their associated functions.

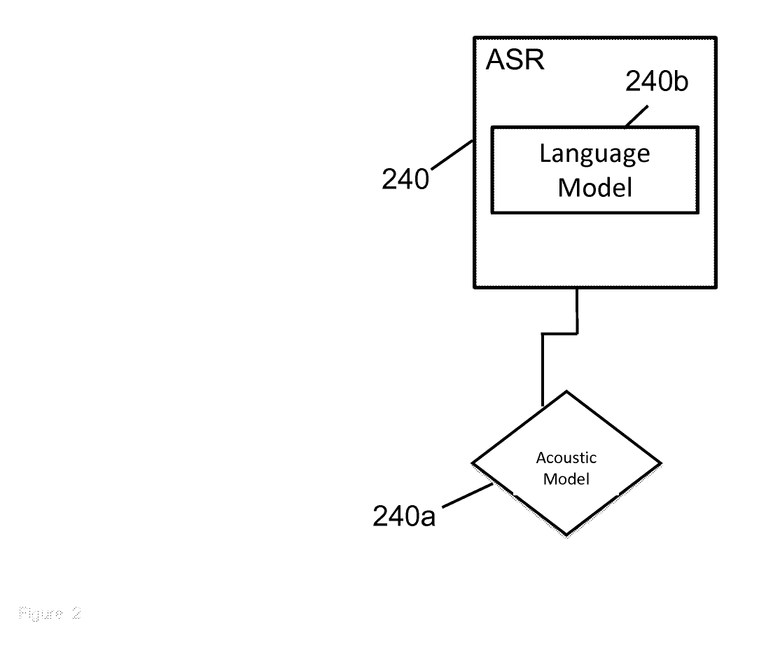

FIG. 2 illustrates a schematic diagram of an exemplary ASR, according to its embodiments. ASR 240 is a module configured as an automatic speech recognizer to receive human speech in machine readable form and convert said speech into text. ASR 240 includes acoustic model 240a and a memory-resident language model 240b, identically to language model 140b. The acoustic model 240a is a module configured as an acoustic model for the ASR 240. Distinctive from the ASR 140, the acoustic model 240a is configured to be dynamically re-programmed as needed to optimize the quality of the speech recognition. For example, the acoustic model 240a might be programmed with a standard US English acoustic model, a US Cajun English acoustic model, or a US Boston English acoustic model, etc. The ASR 240 downloads the desired acoustic model to the acoustic model 240a.

The acoustic model 240a can be user selected, i.e. the user selects the desired acoustic model. The acoustic model 240a may be automatically selected by software onboard depending on the application. For example, if the application expects a speaker with certain characteristics, e.g. accent, cadence, etc, the application may select an acoustic model optimized for said speaker. Further the application can change select different acoustic model 240a as needed.

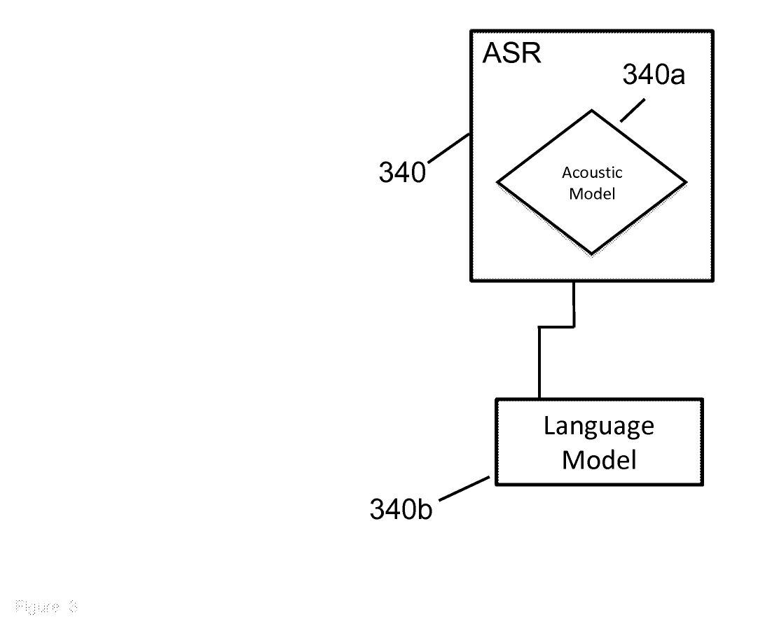

FIG. 3 illustrates a schematic diagram of an exemplary ASR, according to its embodiments. ASR 340 is a module configured as an automatic speech recognizer to receive human speech in machine readable form and convert said speech into text. ASR 340 includes a memory-resident acoustic model 340a and language model 340b. The language model 340b, identical to the language model 340b, is a module configured as a language model for the ASR 340. Distinctive from the ASR 140, the language model 340b is configured to be re-programmed as needed to optimize the quality of the speech recognition. For example, the language model 340b might be programmed with a standard Parisian French language model, a Haitian French model, a Quebec French language model, etc. The ASR 340 downloads the desired language model to the language model 340b.

The language model 340b can be user selected, i.e. the user selects the desired language model. The language model 340b may be automatically selected by software onboard depending on the application. For example, if the application requires command and control functionality, the application may select a grammar file. Alternatively, if the application expects a speaker with certain characteristics, e.g. a regional diction, or the application is being used in technical field , the application may select the language model 340b that is likely to produce the highest quality textual representation. Further the application can different language models 340b as needed.

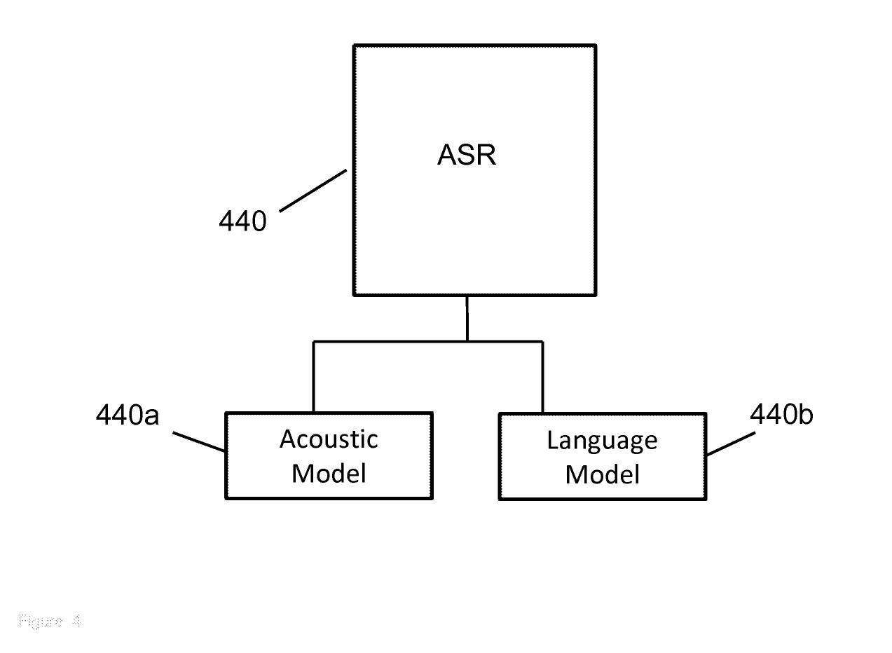

FIG. 4 illustrates a schematic diagram of an exemplary ASR, according to its embodiments. ASR 440 is a module configured as an automatic speech recognizer to receive human speech in machine readable form and convert said speech into text. The acoustic model 440a is a module configured as a language model for the ASR 440. The language model 440b is a module configured as a language model. Distinctive from the ASR 140, the acoustic model 440a is configured to be re-programmed as needed to optimize the quality of the speech recognition. The language model 440b is also configured to be re-programmed as needed to optimize the quality of the speech recognition. For example, the acoustic model 440a might be programmed with a standard US English acoustic model, a US Cajun English acoustic model, or a US Boston English acoustic model, etc. The ASR 440 downloads the desired acoustic model to the acoustic model 440a. Similarly, the language model 440b might be programmed with a standard Parisian French language model, a Haitian French model, a Quebec French language model, etc. The ASR 440 downloads the desired language model to the language model 440b.

Both the acoustic model 440a and language model 440b can be user selected, i.e. the user selects the desired language and acoustic models. Additionally, either, both or neither may be automatically selected by software onboard depending on the application. As explained above, if the application expects a speaker with certain characteristics, e.g. accent, cadence, etc., the application may select an acoustic model optimized for said speaker. Similarly, if the application requires command and control functionality, the application may select a grammar file. Alternatively, if the application expects a speaker with certain characteristics, e.g. a regional diction, or the application is being used in technical field, the application may select the language model 440b that is likely to produce the highest quality textual representation. Further the application can different language models 440b as needed.

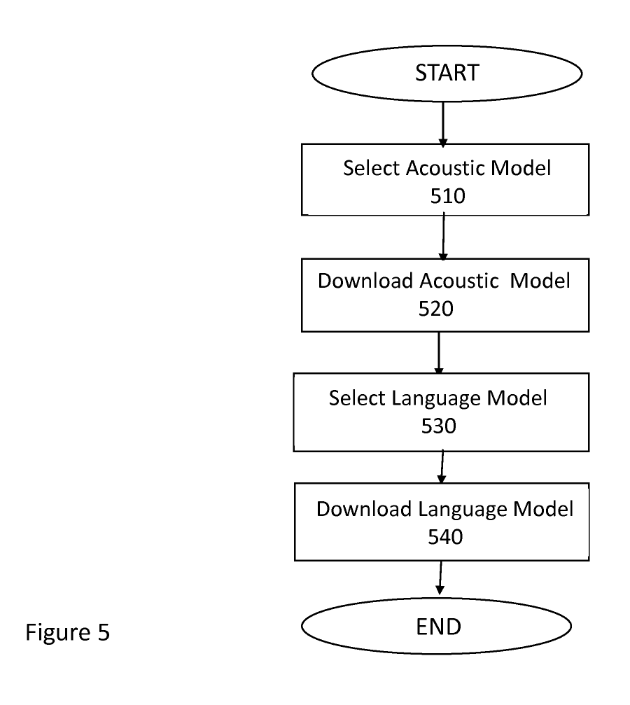

FIG. 5 illustrates a flow diagram of an exemplary embodiment. At step 510, the ASR 140 selects the best acoustic model for the desired speech recognition. The best acoustic model is the one that will give the most accurate textual transcription of the input speech, i.e. create a sequence of diphones corresponding to the input human speech. At step 520, ASR 140 obtains the acoustic model. The acoustic model may be downloaded from the internet, from a mass storage device, onboard memory, etc. At step 530 ASR 140 selects the best language model for the desired speech recognition. The best language model is the one that will give the most accurate textual representation from said sequence of diphones. At step 540, the language model may be downloaded from internet, a mass storage device, onboard memory, etc.

1. A computer system configured to convert human speech into text comprising:
a first module configured to receive human speech; and
a second module configured as a dynamically reconfigurable automatic speech recognition (ASR) engine comprising:
a language model, and
an acoustic model,
wherein at least one of the language model and the acoustic model is dynamically reconfigurable.

2. The computer system according to claim 1, wherein the language model is dynamically reconfigurable, and wherein the ASR is configured to dynamically reconfigure the language model by downloading a new language model and configuring the ASR to implement the new language model.

3. The computer system according to claim 1, wherein the acoustic model is dynamically reconfigurable, and wherein the ASR is configured to dynamically reconfigure the acoustic model by downloading a new acoustic model and configuring the ASR to implement the new acoustic model.
